(19) United States
(12) Patent Application Publication
(10) Pub. No.: US 2006/0229190 A1
(43) Pub. Date: Oct. 12, 2006

(54) Regeneration process for activated carbon for fuel purification

(75) Inventors: Tiejun Zhang, Mount Pleasant, SC (US); James R. Miller, Roanoke, VA (US)

Correspondence Address: MEADWESTVACO CORPORATION, REGIONAL OFFICE BUILDING, PO BOX 118005, CHARLESTON, SC, 29423-8005, US

(73) Assignee: MeadWestvaco Corporation, One High Ridge Park, Stamford, CT (US)

(21) Appl. No.: 11/229,137

(22) Filed: Sep. 16, 2005

Related U.S. Application Data
(63) Continuation-in-part of application No. 11/101,041, filed on Apr. 7, 2005.

(51) Int. Cl. B01J 20/34

(52) U.S. Cl. 502/56

(57) ABSTRACT

A process is disclosed for regeneration of an activated carbon, characterized by inclusion therein of polymerized phosphoric acid, after having been spent by use in purification and decolorization of hydrocarbon fuel, particularly gasoline. The invention process includes the steps of evaporation of gasoline, devolatization of color bodies, and oxidation of color body residues, which steps may be carried out sequentially or accomplished in a single unit operation.

This application is a continuation-in-part application of commonly-owned co-pending U.S. patent application Ser. No. 11/101,041, filed on Apr. 7, 2005.

### BACKGROUND

1. Field of the Invention

This invention relates to a process for regeneration of activated carbon used in the decolorization and purification of hydrocarbon fuel. In particular, the invention relates to a method for the contaminated activated carbon involving evaporation of gasoline, devolatization of color bodies, and oxidation of color body residues. The regeneration process may be accomplished in consecutive steps or accomplished continuously in a single unit operation.

2. Background of the Invention

Activated carbon is a well-established adsorbent material for use as a clarifying media for removal of color bodies from a variety of sources. In particular, activated carbon recently has been disclosed to be useful in the decolorization and purification of hydrocarbon fuel.

US Patent Application 2004/0,129,608 discloses the process of decolorizing liquid hydrocarbon fuel such as gasoline fuels using decolorizing carbon. The process involves contacting the liquid fuel with activated carbon by passing the fuel through a carbon filter (possibly multiple carbon-filled columns) or by introducing particles of carbon into the liquid fuel and recovering said particles after treatment. Traces of impurities include indanes, naphthalenes, phenanthrenes, pyrene, alkyl benzene, and mixture thereof. The published patent application further teaches that any carbon source may be used to prepare the decolorizing carbon employed in the present invention. Carbons derived from wood, coconut, or coal are taught as preferred. The carbon may be activated, for example, by acid, alkali, or steam treatment. Suitable decolorizing carbons are described in Kirk-Othmer Encyclopedia of Chemical Technology, 3rd Edition, Vol 4, pages 562 to 569.

Also, multiple co-pending applications (specifically: assigned Ser. No. 11/093,977; assigned Ser. No. 11/093,679; assigned Ser. No. 11/093,975; assigned Ser. No. 11/093,976; assigned Ser. No. 11/093,678; and assigned Ser. No. 11/094,731) were filed on Mar. 30, 2005, commonly-owned with the parent application identified above, which disclose an activated carbon (referred to herein as “novel activated carbon”) and processes for preparation thereof. Said novel activated carbon is particularly suited for purifying and reducing the color of a hydrocarbon fuel, such as gasoline. A primary characteristic of said novel activated carbon is the presence thereon of polymerized phosphoric acid, which characteristic may be achieved by raising the activation temperature from the range of 800°-1100° F. to the range of 1150°-1600° F. in the phosphoric acid activation of a wood based carbon. Alternatively, a similar result is achieved by post heat-treating a phosphoric acid activated carbon at a temperature of from 1000°-2000° F. for at least 5 minutes in an atmosphere of inert gases or carbon dioxide.

A primary characteristic of said novel activated carbon is the presence thereon of polymerized phosphate, which characteristic may be achieved by raising the activation temperature from the range of 800°-1100° F. to the range of 1150°-1600° F. in the phosphoric acid activation of a wood based carbon. Alternatively, a similar result is achieved by post heat-treating a phosphoric acid activated carbon at a temperature of from 1000°-2000° F. for at least 5 minutes in an atmosphere of inert gases or carbon dioxide or by adding phosphoric acid to an activated carbon that is subsequently heat treated at a temperature of from 1000°-2000° F.

In conventional regeneration of spent activated carbon, the objective is to restore adsorbent porosity by oxidation of organic color bodies at a high temperature, typically in a combustion flue gas atmosphere that contains abundant steam. However, in the case of said novel activated carbon's special affinity for capturing impurities and/or color bodies found in hydrocarbon fuel, the adsorbent relies on the presence of polymerized phosphate, rather than porosity alone, to provide the majority of adsorption sites for gasoline decolorization. Consequently, for high efficiency regeneration of the spent novel activated carbon adsorbent, there is a need to develop a process that restores adsorbent porosity without resulting in a significant loss of polymerized phosphate. Restoring porosity while causing loss of polymerized phosphate exerts a permanent damage to adsorbent adsorption capacity for gasoline purification/decolorization and, thus, must be avoided. Lacking in the prior art, however, and not suggested by any known prior art teaching, is a means for efficiently regenerating the spent activated carbon material used for hydrocarbon fuel purification/decolorization. Therefore, the object of the invention is the provision of a novel method for regenerating spent activated carbon material used for hydrocarbon fuel purification/decolorization.

### SUMMARY OF THE INVENTION

The object of the invention is achieved in a process for regenerating spent activated carbon used in purifying and/or decolorizing hydrocarbon fuel, wherein the activated carbon is characterized by inclusion therein of polymerized phosphate or of reduced transition metals. The invention process includes the steps of evaporation of gasoline, devolatization of color bodies, and oxidation of color body residues, which steps may be carried out sequentially or accomplished in a single unit operation.

### DESCRIPTION OF THE PREFERRED EMBODIMENTS

The disclosure of the preferred embodiments, including the best known mode of carrying out the invention process, is set forth in the description and series of examples that follow.

In a commercial application of the activated carbon in purifying and decolorizing a hydrocarbon fuel by contacting the initial, newly manufactured (“virgin”) carbon with the fuel, the carbon eventually loses its ability to adsorb the contaminant color bodies and is considered “spent.” For the fuel purification process to be economical, it is critical that the spent carbon be recycled by regenerating its ability to purify the fuel and re-introduce it into the decolorization process, normally along with (and usually a lesser amount of) virgin carbon. Therefore, after an initial spent carbon reactivation treatment, subsequent regeneration processing involves treating a mixture of spent virgin carbon and spent (again) previously regenerated carbon. Therefore, for the purposes of this disclosure, the term “virgin carbon” in reference to the “starting carbon” in the herein disclosed and claimed invention is considered to include, respectively, carbon that has not been spent and carbon that has been spent and then regenerated for one or more times for re-use.

The invention regeneration process is particularly effective for regenerating spent activated carbon contaminated by use in gasoline decolorizing and purification. Multiple technical approaches have been developed for regenerating the spent carbon which achieves re-activation thereof, but without destruction of the active sites provided thereon for color body removal. The regeneration process may be accomplished in consecutive steps of evaporation of gasoline (up to 400° F.), devolatization of color bodies (heated up to 2000° F. in an inert atmosphere), and oxidation of color body residues or accomplished continuously in a single unit operation. Preferred drying temperature is ambient to 400° F. The invention activated carbon regeneration process is shown to achieve full (100%), or near full, regeneration after the activated carbon-based adsorbent has been used for gasoline purification. Subsequent to the disclosure of the parent application, it has been learned that after multiple regeneration iterations of the repeatedly spent activated carbon special processing may be required to achieve the level of regeneration to achieve equivalent gasoline decolorization performance as achieved in previous regenerations of the same activated carbon.

### EXAMPLES

The following examples further describe the invention activated carbon regeneration process. In these examples, a greater capacity of gasoline decolorizing is represented by a greater increase in Saybolt value after a given gasoline is treated with activated carbon at a constant dosage. Specified in ASTM D-156/1500 for measuring the color of petroleum products including gasoline, Saybolt value ranges from −32 (darkest color) to 32 (least color). The higher the Saybolt value, the less color the gasoline has. While the higher the Saybolt value, after decolorization, reflects the less color there is in the liquid, it is a relative term. Thus, the effectiveness of decolorization using a specified amount of activated carbon is relative to (and, obviously, affected by) the Saybolt value of the feed gasoline.

Three grams of granular adsorbent (virgin or regenerated) were ground for 60 seconds in a Spex mill for the gasoline decolorizing isotherm tests. Unless noted otherwise, a constant carbon dosage of 1.0 wt % was used with the same severe color gasoline (internally identified by MeadWestvaco as 1370-R-04 or 1550-R-04) with a Saybolt value of −24.7. The solid/liquid contact time was kept constant at 60 minutes at ambient temperature with stirring. The Saybolt value of carbon-treated gasoline was measured after the carbon particles were removed from the gasoline by filtration.

The content of polymerized phosphate (% PP) is determined by difference between the total phosphate and water-soluble phosphate. For total phosphate analysis, exactly 0.50 grams of dried spex-milled powder was microwave-digested with sulfuric and nitric acids. For water-soluble phosphate analysis, exactly 0.50 grams of the same dried spex-milled powder was boiled in nanopure water for 15 minutes. After solids were removed by filtration, aliquots of the filtrates were measured for phosphorous concentration by ICP. The phosphate content on adsorbent is expressed as % H₃PO₄. The polymerized phosphate determined by this method is sometimes called fixed phosphate or water-insoluble phosphate.

After the novel activated carbon-based adsorbent has been used for gasoline purification to a desirable Saybolt value of decolorization and is removed from an adsorption column, the spent adsorbent, loaded with color bodies and gasoline, is regenerated. Comparison of the Saybolt value subsequently achieved in use of the regenerated activated carbon is the primary measure of the success (or degree thereof) of the regeneration process. The regeneration may be completed in consecutive steps for evaporation of gasoline (drying up to 400° F.), devolatization of color bodies (heated up to 2000° F. in an inert atmosphere), and oxidation of color body residues (heated up to 2000° F. in an oxidative atmosphere). If done in multiple unit operations, the steps of evaporation, devolatization, and oxidation may be carried out in a tube reactor, rotary kiln or other furnace forms. The evaporation step may be carried out with the assistance of a vacuum source and/or sweep gas such as air, nitrogen, CO2, or other common gases in a heated or non-heated device. Alternatively, regeneration may also be completed in one single unit operation that accomplishes all three tasks. If done in one single unit operation, regeneration may be carried out in a tube reactor, a rotary kiln or other furnace forms. In any case, however, appropriate conditions must be used in order to minimize loss of polymerized phosphate while restoring porosity.

Carbons which are extensively spent show decreased pore volume, high density relative to virgin carbon, and low polymerized phosphate content. These carbons may require additional processing during regeneration. One approach is to increase regeneration residence time in order to increase pore volume and decrease density. Successful regeneration/reactivation of an extensively spent carbon is its repair to an increased pore volume and a decreased density to within 20% of virgin levels, preferably 15% of virgin levels.

As shown in examples 1 to 7, the spent carbons had minimal decolorization capability, as indicated by a Saybolt value enhancement of only <−16, as compared to −24.7 for the untreated feed gasoline. The spent carbons shown in examples 1 to 6 also had an apparent density (AD) that was at least 20% higher than the virgin carbon. In example 7, an extensively spent carbon had an apparent density that was about 45% higher the density of the virgin carbon.

### Example 1

Table I provides a summary of regeneration results when pre-dried spent novel activated carbon is subjected to heat treatment in an inert nitrogen or steam atmosphere in a fluidized bed. The spent adsorbent was pre-dried in a convection oven at 221° F. prior to fluidization regeneration.

TABLE I
Lab Tube Reactor* Fluidized Bed Regeneration in Nitrogen or Steam

| | | | | | Pores | | |
|---|---|---|---|---|---|---|---|
| Conditions | | | % | Density | (cc/g) | BET | Saybolt |
| Atmo. | T(° F.) | (min) | PP | (g/c, db¹) | <1000 Å | (m2/g) | Value |
| Virgin carbon | | | 4.1 | 0.34 | 1.03 | 1387 | 21 |
| Spent Carbon | | | | 0.45 | | | <−16 |
| N2 | 1550 | 15 | 4.6 | 0.37 | 0.78 | 1001 | 16 |
| N2 | 1550 | 60 | | 0.37 | 0.72 | 953 | 17 |
| N2 | 1700 | 15 | | 0.37 | 0.77 | 1002 | 17 |
| H2O | 1400 | 15 | 1.0 | 0.34 | 0.90 | 1180 | 13 |
| H2O | 1550 | 15 | | 0.31 | 1.05 | 1417 | 13 |
| H2O | 1700 | 15 | | 0.25 | 1.37 | 1889 | 14 |
| ¹db—dry basis | | | | | | | |
| *Lab-scale regeneration was carried out in a 1-inch diameter vertical tube reactor. The quartz tube reactor was externally heated by electricity. In each run, exactly 10 grams of dried spent adsorbent were loaded into the reactor at ambient temperature. Either a fixed bed or a fluidized bed was maintained by adjusting the gas superficial velocity. The reactor bed was heated under a N₂ flow | | | | | | | |
| # to the target temperature and then switched to the desired gas flow. After a designated residence time, the gas flow was switched back to N₂ and the heat was turned off. The bed was let cool under N₂ flow. | | | | | | | |

It is clear from Table I that nitrogen regeneration did not cause loss of polymerized phosphate (PP) but only restored 70-76% of the pore volume. As a result, the adsorption capacity as measured by Saybolt value was not restored to the virgin carbon level (16-17 vs. 21 virgin). On the other hand, steam regeneration caused a drastic loss of polymerized phosphate and thus resulted in a worse Saybolt value (13-14 vs. 21 virgin), although the porosity had been fully restored and even enhanced due to additional steam activation during the regeneration. Varying the regeneration temperature from 1550° F. to 1700° F. with N₂ or from 1400° to 1700° F. with steam or increasing residence time with N₂ at 1550° F. from 15 to 60 minutes had a slight positive impact on the Saybolt value. It is also noted in Table I that the effect of restoring the carbon density to the virgin level or even lower is not necessarily to achieve full recovery of virgin carbon decolorization capacity.

### Example 2

Tests were conducted to compare the effects of fluidized bed regeneration in steam versus carbon dioxide. The results are presented in Table II.

TABLE II
Lab Tube Reactor Fluidized Bed Regeneration in Steam or
Carbon Dioxide

| | | | | | Pores | | |
|---|---|---|---|---|---|---|---|
| Conditions | | | % | Density | (cc/g) | BET | Saybolt |
| Atmo. | T(° F.) | (min) | PP | (g/c, db) | <1000 Å | (m2/g) | Value |
| Virgin carbon | | | 4.1 | 0.34 | 1.03 | 1387 | 21 |
| Spent Carbon | | | | 0.45 | | | <−16 |
| H2O | 1550 | 15 | 0.5 | 0.34 | 0.90 | 1180 | 13 |
| CO2 | 1550 | 15 | 4.4 | 0.36 | 0.81 | 1092 | 19 |

The loss of polymerized phosphate is greatly decreased when steam is replaced with carbon dioxide in a fluidized bed tube reactor. As seen in Table II, switching from pure steam to pure carbon dioxide under the same temperature and residence time improved the Saybolt value from 13 to 19, which is near the virgin carbon level. This is consistent with the improved retention of polymerized phosphate, which was 4.4% on the CO₂-regenerated carbon as compared to 0.5% on the steam-regenerated carbons.

Thus, regeneration with carbon dioxide appears to be a more plausible option than with pure steam or steam-containing atmosphere. A mix of carbon dioxide with an inert gas such as N₂ is also acceptable.

### Example 3

Regeneration experiments were also carried out in a pilot scale rotary kiln. Simulated flue gas (SFG) was typically used. Carbon dioxide was also tested in a limited experiment. When technically acceptable, a rotary kiln is usually considered to be a more practical and economic option than a fluidized bed reactor for large scale applications. Pilot scale regeneration was carried out in the 7.5-inch diameter rotary kiln. The kiln was externally heated by combustion of natural gas. In each run, about 0.25 to 1.0 lb dry basis of spent adsorbent was loaded into the kiln. Without pre-drying, the spent carbon adsorbent would be loaded at ambient temperature and then heated up to the target temperature in N₂ flow. If pre-dried or pre-volatilized, the feed would be loaded into the kiln after it was already heated to the target temperature. Simulated flue gas was prepared by mixing pre-determined flows of N₂, CO₂, and steam. After a designated length of residence time for regeneration, the kiln was switched to N₂ flow and allowed to cool under N₂ flow.

Table III provides a summary of regeneration results when the spent carbon was directly charged (without pre-drying) into a 7.5″ rotary kiln. The kiln was then heated up in nitrogen and the adsorbent was regenerated in a simulated flue gas at 1550° F. for one hour.

TABLE III
Pilot Rotary Kiln Regeneration with Simulated Flue Gas at 1550° F.

| Conditions | | | | Yield | | Density | Pores (cc/g) | BET | Saybolt |
|---|---|---|---|---|---|---|---|---|---|
| T(° F.) | (min) | SFG* | SV(ft/s) | (vol %, db) | % PP | (g/cc, db) | <1000 Å | (m2/g) | Value |
| Virgin carbon | | | | | 3.1 | 0.34 | 1.00 | 1371 | 20 |
| Spent Carbon | | | | | | 0.43 | | | <−16 |
| 1550 | 60 | 8:1:3 | 0.29 | 92 | 1.2 | 0.34 | 0.97 | 1270 | 16 |

*Ratios of N2:CO2:H2O by volume, with no O2.

As shown in Table III, one hour of flue gas rotary kiln regeneration resulted in a Saybolt value of 16. This represents a significant improvement over fluidized bed steam regeneration (13˜14 Saybolt) but falls below fluidized bed carbon dioxide regeneration, as presented in Table II. Such an outcome was a result of several factors that had conflicting effects, including the effects of a reduced gas superficial velocity (SV) (0.29 ft/s vs. 0.70 ft/s for fluidized bed), co-presence of steam and carbon dioxide in flue gas composition, and an extended residence time. The presence of steam and the extended residence time caused a significant decrease of polymerized phosphate content, from 3.1% in the virgin carbon to 1.2% in the regenerated carbon, which corresponded to the decline in Saybolt value from 20 to 16. The decline in Saybolt value occurred despite the facts that density and pore volume had been restored to the virgin or near the virgin level.

### Example 4

To improve regeneration efficiency in the pilot rotary kiln, the bed temperature was increased from 1550° to 1750° F. and the gas superficial velocity was further reduced from 0.29 to 0.22-0.24 ft/sec. The data are presented in Table IV. In both experiments, gasoline spent carbon was directly charged into the furnace without the pre-drying and pre-devolatization steps.

As seen in Table IV, almost full regeneration was achieved with 6-12 minutes of residence time, with 19-20 Saybolt value as compared to 20 Saybolt for virgin carbon. The key is the greater retention of polymerized phosphate, with 2.8-2.9% in the regenerated carbons as compared to 3.1% in the virgin carbon, although the recovery of pore volume is only 78-92% and the density is still higher (5-15%) than the virgin carbon.

TABLE IV
Direct Regeneration in Pilot Rotary Kiln with Simulated Flue Gas at 1750° F.

| Conditions | | | | Yield | | Density | Pores (cc/g) | BET | Saybolt |
|---|---|---|---|---|---|---|---|---|---|
| T(° F.) | (min) | SFG* | SV(ft/s) | (vol %, db) | % PP | (g/c db) | <1000 Å | (m2/g) | Value |
| Virgin carbon | | | | | 3.1 | 0.34 | 1.00 | 1371 | 20 |
| Spent Carbon | | | | | | 0.43 | | | <−16 |
| 1750 | 6 | 8:1:3 | 0.24 | 92 | 2.8 | 0.36 | 0.92 | 1187 | 20 |
| 1750 | 12 | 8:1:2 | 0.22 | 92 | 2.9 | 0.39 | 0.78 | 1035 | 19 |

*Ratios of N2:CO2:H2O by volume, with no O2

### Example 5

Table V provides a comparison of simulated flue gas and carbon dioxide in pilot rotary kiln regeneration. As in the case of fluidization regeneration presented in example 2, though to a lesser extent, carbon dioxide has an advantages over flue gas in terms of retaining more polymerized phosphate while restoring porosity. As a result, the CO₂-regenerated adsorbent yielded a greater Saybolt value than the SFG-regenerated material at the 0.5% carbon dosage.

TABLE V
Pilot Rotary Kiln Regeneration in Simulated Flue Gas or Carbon Dioxide

| Conditions | | | Yield | | Density | Pores (cc/g) | BET | Saybolt Value* | | |
|---|---|---|---|---|---|---|---|---|---|---|
| T(° F.) | (min) | Gas | (vol %, db) | % PP | (g/c db) | <1000 Å | (m2/g) | 0.5 | 1.0 | 2.0 |
| Virgin carbon | | | | 3.1 | 0.34 | 1.00 | 1371 | 14 | 20 | 21 |
| Spent Caron | | | | | 0.42 | | | | <−16 | |
| 1750 | 18 | SFG | 87 | 2.7 | 0.39 | 0.80 | 1052 | 11 | 19 | 22 |
| 1750 | 18 | CO2 | 86 | 3.0 | 0.37 | 0.87 | 1147 | 13 | 19 | 22 |

*By isotherm tests at 0.5, 1.0, and 2.0% dosages

### Example 6

Additional experiments were carried out after the spent carbon was pre-devolatilized in nitrogen at 1750° F. prior to regeneration with simulated flue gas at the same temperature. As seen in Table VI, near full regeneration was achieved at 1750° F., within 12-24 minutes of residence time and 0.22-0.27 ft/sec superficial velocity, with 18-19 Saybolt value as compared to 20 Saybolt for the virgin carbon. As in example 4, the key is the greater retention of polymerized phosphate, with 2.5-2.7% in the regenerated carbons as compared to 3.1% in the virgin carbon, although the recovery of pore volume is only 77-84% and the density is still 10-15% above the virgin carbon.

TABLE VI
Regeneration of Pre-Devolatized Spent Carbon
in Pilot Rotary Kiln with Simulated Flue Gas at 1750° F.

| Conditions | | | | Yield | | Density | Pores (cc/g) | BET | Saybolt |
|---|---|---|---|---|---|---|---|---|---|
| T(° F.) | (min) | SFG* | SV(ft/s) | (vol %, db) | % PP | (g/c db) | <1000 Å | (m2/g) | Value |
| Virgin carbon | | | | | 3.1 | 0.34 | 1.00 | 1371 | 20 |
| Spent Carbon | | | | | | 0.43 | | | <−16 |
| 1750 | 12 | 8:1:2 | 0.22 | 89 | 2.7 | 0.39 | 0.77 | 1024 | 18 |
| 1750 | 24 | 8:1:2 | 0.22 | 89 | 2.6 | 0.39 | 0.79 | 1038 | 18 |
| 1750 | 12 | 8:1:4 | 0.27 | 85 | 2.6 | 0.39 | 0.78 | 1021 | 18 |
| 1750 | 24 | 8:1:4 | 0.27 | 82 | 2.5 | 0.38 | 0.84 | 1077 | 19 |
| 1750 | 18 | 8:1:3 | 0.24 | 87 | 2.7 | 0.39 | 0.80 | 1052 | 19 |

*Ratios of N2:CO2:H2O by volume, with no O2

To summarize, full or near full regeneration (of the activated carbon which became spent in decolorizing gasoline) is achievable in rotary kiln with simulated flue gas or carbon dioxide. When flue gas is used, kiln conditions must be chosen not to cause intensive mass transfer but the bed temperature must be kept high (such as 1750° F.) to limit loss of polymerized phosphate and thus reduce any permanent damage on adsorption capacity. When carbon dioxide or a mix of carbon dioxide and inert gas such as N₂ are used, the loss of polymerized phosphate is minimal and full regeneration is more readily achievable without causing any permanent damage on adsorption capacity.

### Example 7

Carbons which are extensively spent show decreased pore volume, high density relative to virgin carbon, and low polymerized phosphate content. These carbons may require additional processing during regeneration. One approach is to increase regeneration residence time in order to increase pore volume and decrease density. The data in Table VII illustrates how increasing residence time during regeneration (from 12 to 108 minutes in SFG at 1750° F. in the 7.5″ pilot scale rotary kiln) of an extensively spent carbon increased pore volume and decreased density to within 15% of virgin levels.

TABLE VII
Regeneration of Extensively Spent Carbon with Simulated Flue Gas at
1750° F. with Extended Residence Times

| Conditions | | | | Yield | | Density | Pores (cc/g) | BET | Saybolt |
|---|---|---|---|---|---|---|---|---|---|
| T (F.) | (min) | SFG | SV (ft/s) | (vol % db) | % PP | (g/cc db) | <1000 A | (m2/g) | Value |
| Virgin Carbon | | | | | 3.1 | 0.34 | 1.00 | 1371 | 20 |
| Spent Carbon | | | | | 1.7 | 0.49 | | | |
| 1750 | 12 | 8:1:2 | 0.22 | 94 | 1.1 | 0.45 | 0.59 | 646 | 10 |
| 1750 | 24 | 8:1:2 | 0.22 | 92 | 1.3 | 0.43 | 0.62 | 714 | 11 |
| 1750 | 48 | 8:1:2 | 0.22 | 94 | 0.9 | 0.43 | 0.67 | 815 | 11 |
| 1750 | 108 | 8:1:2 | 0.22 | 91 | 1.1 | 0.39 | 0.80 | 998 | 16 |

The extensively spent carbon in Table VII has a density of 0.49 g/cc, while the spent carbons in previous examples had densities of 0.42-0.43 g/cc. Compared with a Saybolt value of 20 at 1% dosage with the virgin carbon, regeneration of the extensively spent carbon for 12 minutes resulted in a density of 0.45 g/cc and Saybolt value of only 10 at 1% dosage, while regeneration for 108 minutes resulted in a density of 0.38-0.39 g/cc and a much improved Saybolt value of 15-16 at 1% dosage.

Despite careful selection of process conditions, regeneration of spent carbon with steam-containing purge gases such as combustion flue gas will inevitably result in a further reduction of polymerized phosphate and thus causes damage to the decolorizing capacity. Such loss of decolorizing capacity would not be recovered even if the carbon porosity and density was restored to the virgin carbon levels. In those cases, improvements to Saybolt levels can be achieved by increasing polymerized phosphate content to levels closer to virgin levels.

The foregoing description relates to embodiments of the present invention, and changes and modifications may be made therein without departing from the scope of the invention as defined in the following claims.

What is claimed is:

1. An improved process for the regeneration of an activated carbon adsorbent characterized by an inclusion of polymerized phosphate thereon and having been spent in a process for the purification and decolorization of hydrocarbon fuel, said regeneration process comprising the steps of:
(a) evaporation of the hydrocarbon fuel from the spent carbon;
(b) devolatilization of color bodies; and
(c) oxidation of color body residues,
wherein the improvement resides in a regenerated activated carbon adsorbent having a density variation no greater than 20% from the density of the virgin activated carbon.

2. The improved process of claim 1 wherein the activated carbon is a member selected from the group consisting of a first activated carbon derived from lignocellulosic material activated with phosphoric acid at an activation temperature from about 1150° to about 1600° F. and a second activated carbon derived from a member of the group consisting of lignocellulosic material and coal that was subjected to a post-activation heat treatment from about 1000° to about 2000° F.

3. The improved process of claim 2 wherein the lignocellulosic material is a member selected from the group consisting of wood, coconut, nut shell and fruit pit.

4. The improved process of claim 2 wherein the second activated carbon is contacted with phosphoric acid prior to the post-activation heat treatment.

5. The improved process of claim 1 wherein the inclusion of polymerized phosphate on the activated carbon is in the amount of 0.5-10 wt % both prior to the virgin carbon becoming “spent” in the fuel purification and decolorization process and after regeneration by steps (a), (b), and (c).

6. The improved process of claim 5 wherein the inclusion of polymerized phosphate is in the amount of 2-7.5 wt %.

7. The improved process of claim 1 wherein step (a) comprises drying the spent carbon at a temperature up to about 400° F., step (b) comprises heating the dried spent carbon up to a temperature of about 2000° F. in an inert atmosphere, and step (c) comprises heating the spent carbon up to a temperature of about 2000° F. in an oxidative atmosphere.

8. The improved process of claim 1 wherein steps (a), (b), and (c) are accomplished in a single unit operation in an oxidative atmosphere at a temperature up to about 2000° F.

9. The improved process of claim 7 wherein the oxidative atmosphere is achieved with a gas selected from a member of the group consisting of steam, carbon dioxide, combustion flue gas and a mix thereof.

10. The improved process of claim 8 wherein the oxidative atmosphere is achieved with a gas selected from a member of the group consisting of steam, carbon dioxide, combustion flue gas and a mix thereof.

11. The improved process of claim 7 wherein the inert atmosphere is achieved with an inert gas selected from a member of the group consisting of nitrogen, helium, argon, neon, krypton, xenon, radon, and a mix thereof.

12. The improved process of claim 7 wherein steps (b) and (c) take place at a temperature ranging from about 1000° to about 2000° F.

13. The improved process of claim 12 wherein the steps (b) and (c) take place at a temperature ranging from about 1600° to about 2000° F.

14. The improved process of claim 8 wherein steps (b) and (c) take place at a temperature ranging from about 1000° to about 2000° F.

15. The improved process of claim 1 wherein the process is conducted in a reactor selected from the group consisting of a tube reactor, a rotary kiln, and a multihearth furnace.

16. The improved process of claim 1 wherein the improvement resides in a regenerated activated carbon adsorbent having a density variation no greater than 15% from the density of the virgin activated carbon.

17. The improved process of claim 7 wherein the preferred temperature range is ambient temperature to about 400° F.
